(19) United States
(12) Patent Application Publication
(10) Pub. No.: US 2011/0159927 A1
(43) Pub. Date: Jun. 30, 2011

(54) MOBILE DEVICE AND METHOD FOR PROVIDING CONTROL KEY INTERACTING WITH APPLICATION

(75) Inventor: Woosik CHOI, Seoul (KR)

(73) Assignee: IRIVER LIMITED

(21) Appl. No.: 12/962,555

(22) Filed: Dec. 7, 2010

(30) Foreign Application Priority Data
Dec. 30, 2009 (KR) 10-2009-0133773

(51) Int. Cl. H04M 1/00; G06F 3/02; G06F 3/041

(52) U.S. Cl. 455/566; 345/168

(57) ABSTRACT

Provided is a mobile device for providing control key interacting with application. The mobile device stores at least one or more applications executable by it. The mobile device includes an application executing module, a display module and an interactive input module. The application executing module activates an application, which is selected from among the applications by a user, to execute an active application. The display module displays an execution screen of the active application. The interactive input module receives a control command for controlling the active application from the user. The interactive input module provides a control key which is arranged to be suitable for control of the active application by interacting with the active application, and receives the control command for controlling the active application through the control key.

### CROSS-REFERENCE TO RELATED APPLICATIONS

This application claims priority under 35 U.S.C. §119 to Korean Patent Application No. 10-2009-0133773, filed on Dec. 30, 2009, the disclosure of which is incorporated herein by reference in its entirety.

### TECHNICAL FIELD

The present invention relates to a mobile device and method for providing control key interacting with application, and in particular, to a mobile device and method for providing control key interacting with application, which provide control keys that interact with applications and may be adaptively changed according to the kinds of applications by interacting with the applications, and thus enable a user to control the mobile device more intuitively and easily.

### BACKGROUND

Typically, users input a command for controlling a mobile device through physically-fixed buttons. Accordingly, users' convenience is more reduced than convenience for user control because of a scheme for arranging through the limited buttons of the mobile device. Moreover, the additional installation of an application is required after the manufacture of the mobile device, and since control should be performed with buttons that have already been fixed in the manufacturing of the mobile device, it is difficult to use the application when a key for appropriate control does not exist.

Due to the development of technology for mobile devices, the functions of the mobile devices are diversified and complicated which include functions such as talking over a telephone, taking a picture and watching television (TV) broadcasting. However, as the functions of the mobile devices are complicated, it is required that users conveniently manipulate the mobile devices. Particularly, interest in a universal design which enables all unskilled users such as children or old people to conveniently manipulate the mobile devices is increasing. Accordingly, requirements for developing an interface which receives a command from a user are recently increasing for improving usability.

### SUMMARY

Accordingly, the present invention provides a mobile device and method for providing control key interacting with application, which provide control keys that interact with applications and may be adaptively changed according to the kinds of applications by interacting with the applications, and thus enable a user to control the mobile device more intuitively and easily.

The present invention also provides a mobile device and method for providing control key interacting with application, which can control applications by arranging the applications that were not considered in the manufacturing of the mobile device and control keys for controlling the applications later because the control keys are not physically provided to the mobile device.

The present invention also provides a mobile device and method for providing control key interacting with application, which implement a control key as a Light Emitting Diode (LED) touch pad and do not provide a control key when the mobile device is not controlled, thereby increasing the use time of a battery and enabling a user to visually obtaining stability.

According to an aspect, there is provided a mobile device, which includes at least one or more applications executable by the mobile device, including: an application executing module activating an application, which is selected from among the applications by a user, to execute an active application; a display module displaying an execution screen of the active application; and an interactive input module receiving a control command for controlling the active application from the user, wherein the interactive input module provides a control key which is arranged to be suitable for control of the active application by interacting with the active application, and receives the control command for controlling the active application through the control key.

The mobile device may further include a database storing the applications, and the control key which is arranged in the interactive input module to be suitable for control of the applications in response to the applications. The application executing module may be executed to provide the control key interacting with the active application through the interactive input module.

The interactive input module may include a Light Emitting Diode (LED) touch pad.

The mobile device may further include a touch input module disposed at a certain region of the display module which displays the execution screen, and sensing touch of the user, wherein the touch input module senses the touch of the user to receive a second control command.

The database may store at least one of: a dial application for making a phone call through the mobile device; a phonebook application for storing names and phone numbers which respectively correspond to the names; a message application for writing a Short Message Service (SMS) message or a Multimedia Message Service (MMS) message and sending the message; a camera application for taking a picture; a music application for replaying music files to provide music; a video application for replaying video files to provide video; a Digital Multimedia Broadcasting (DMB) application for providing a digital broadcasting service; a recording application for recording sound; an image viewer application for viewing image files; and a text viewer application for viewing text files.

When the active application is the dial application, a dial may be provided through the display module, and the control key may include at least one of: a call button for calling to a phone number which is inputted through the dial; a hangup button for hanging up; a save button for storing a phone number inputted through the dial in a phone book; and a message button for sending a message to a phone number which is inputted through the dial.

When the active application is the phonebook application, a stored phone number list may be provided through the display module, and the control key may include at least one of: an UP button for moving upward in the phone number list; a DOWN button for moving downward in the phone number list; an OK button for checking detailed information of a focused phone number in the phone number list; and a message button for sending a message to a focused phone number in the phone number list.

When the active application is the message application, a stored message list may be provided through the display module, and the control key may include at least one of: an UP button for moving upward in the message list; a DOWN button for moving downward in the message list; and an OK button for checking detailed information of a focused message in the message list.

When the active application is the camera application, a captured picture may be provided through the display module, and the control key may include at least one of: a zoom-in button for zooming in the picture; a zoom-out button for zooming out the picture; a shot button for taking the picture; and a mode button for setting a photograph mode.

When the active application is the music application or the video application, an executed file may be provided through the display module, and the control key may include at least one of: a play button for playing files; a pause button for pausing a played file; an FF button for replaying a file succeeding the played file or performing fast forward in the played file; and an REW button for playing a file preceding the played file or performing rewind in the played file.

When the active application is the DMB application, DMB broadcasting may be provided through the display module, and the control key may include at least one of: an OK button for checking information of a channel which is being viewed; an UP button for moving to a channel preceding the channel which is being viewed; and a DOWN button for moving to a channel succeeding the channel which is being viewed.

When the active application is the recording application, a current-recording state may be provided through the display module, and the control key may include an REC button for recording sound.

When the active application is the image viewer application or the text viewer application, a file may be provided through the display module, and the control key may include at least one of: a previous button; a next button; an enlarge button for enlarging a viewer screen; and a reduce button for reducing the viewer screen.

According to another aspect, there is provided a method for providing control key of a mobile device, which includes at least one or more applications, including: activating an application, which is selected from among the applications included in the mobile device by a user, to execute an active application; and providing a control key which is arranged to be suitable for control of the application by interacting with the active application.

Before the executing of an active application, the method may further include arranging and storing, by the mobile device, the applications and the control key to be suitable for control of the applications in response to the applications.

After the providing of a control key, the method may further include receiving a control command for controlling the active application through the control key.

After the receiving of a control command, the method may further include controlling the active application according to the control command.

In the providing of a control key, the control key may be provided through a Light Emitting Diode (LED) touch pad.

The arranging and storing of the applications and the control key may store at least one of: a dial application for making a phone call through the mobile device; a phonebook application for storing names and phone numbers which respectively correspond to the names; a message application for writing a Short Message Service (SMS) message or a Multimedia Message Service (MMS) message and sending the message; a camera application for taking a picture; a music application for replaying music files to provide music; a video application for replaying video files to provide video; a Digital Multimedia Broadcasting (DMB) application for providing a digital broadcasting service; a recording application for recording sound; an image viewer application for viewing image files; and a text viewer application for viewing text files.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a detailed block diagram illustrating a mobile device for providing control key interacting with application according to an embodiment of the present invention.

FIG. 2 is an exemplary diagram for describing a mobile device for providing control key interacting with application according to an embodiment of the present invention.

FIG. 3 is a diagram for describing various applications which may be stored in the mobile device and control keys interacting with the applications.

FIG. 4 is an exemplary diagram illustrating an execution screen of a dial application according to an embodiment of the present invention.

FIG. 5 is an exemplary diagram illustrating an execution screen of a phonebook application of a mobile device for providing control key interacting with application according to an embodiment of the present invention.

FIG. 6 is an exemplary diagram illustrating an execution screen of a message application of a mobile device for providing control key interacting with application according to an embodiment of the present invention.

FIG. 7 is an exemplary diagram illustrating an execution screen of a camera application of a mobile device for providing control key interacting with application according to an embodiment of the present invention.

FIG. 8 is an exemplary diagram illustrating an execution screen of a music application of a mobile device for providing control key interacting with application according to an embodiment of the present invention.

FIG. 9 is an exemplary diagram illustrating an execution screen of a DMB application of a mobile device for providing control key interacting with application according to an embodiment of the present invention.

FIG. 10 is a flowchart illustrating a method for providing control key interacting with application according to an embodiment of the present invention.

### DETAILED DESCRIPTION OF EMBODIMENTS

Hereinafter, the present invention will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A mobile device may include and execute at least one or more applications that may be executed at a mobile device environment.

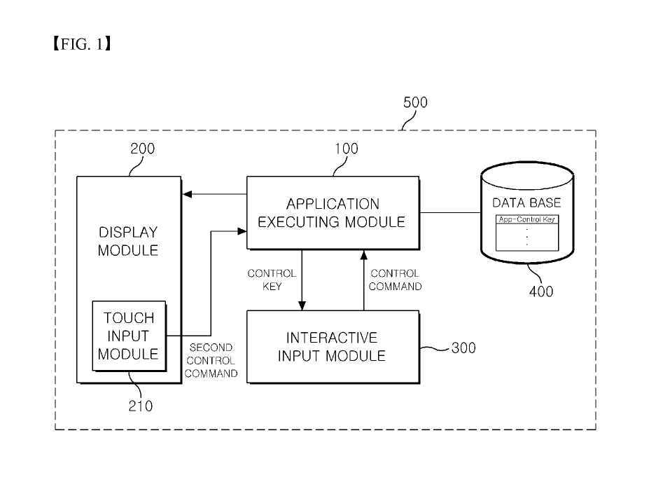

FIG. 1 is a detailed block diagram illustrating a mobile device for providing control key interacting with application according to an embodiment of the present invention.

Referring to FIG. 1, a mobile device 500 for providing control key interacting with application according to an embodiment of the present invention includes an application executing module 100, a display module 200, an interactive input module 300, and a database (DB) 400.

The application executing module 100 activates an application that is selected from among applications by a user and executes the application as an active application.

The display module 200 displays the execution screen of the active application.

The interactive input module 300 provides a control key, and receives a control command for controlling the active application from the user through the control key.

The control key provided through the interactive input module 300 is one that interacts with the active application and is arranged to be suitable for the control of the active application. The interactive input module 300, for example, may be configured with an LED touch pad.

The database 400 stores all kinds of applications that may be included in the mobile device 500 and executed. Furthermore, the database 400 stores the control key including buttons that are arranged to be suitable for the control of a corresponding application in response to the application.

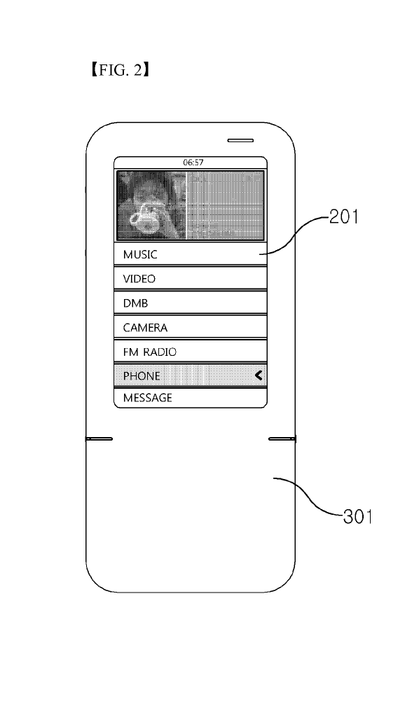

FIG. 2 is an exemplary diagram for describing a mobile device for providing control key interacting with application according to an embodiment of the present invention.

According to an embodiment of the present invention, as illustrated in FIG. 2, the executed results 201 of applications are provided through the display module 200, and control commands for controlling the applications are provided through the control key 301 is arranged through the interactive input module 300, thereby enabling the applications to more quickly and easily manipulated. That is, since a mobile device including a related art touch screen performs display and simultaneously receives an input through a display module, it is difficult to manipulate the mobile device. For example, when a user is viewing Digital Multimedia Broadcasting (DMB), it generally views the DMB with the full screen of the mobile device. In this way, like that where a user switches a channel or view channel information while viewing broadcasting, the control of the mobile device is required. At this point, the display module that provides the DMB through a full screen should be changed into a control mode so as to perform display and simultaneously receive a control command, and thus time is taken. Furthermore, because a control key for receiving a control command is displayed simultaneously with DMB screen, this inevitably disturbs a broadcasting screen that is viewed by the user. For solving these limitations, therefore, the mobile device according to an embodiment of the present invention includes an interactive input module where a control key is arranged independently of a display region.

Moreover, the interactive input module 300 is particularly implemented with an LED touch pad, and thus it needs not include a button that is physically fixed to the outside. A related art button is physically fixed irrespective of whether a user uses the button or not. However, the mobile device according to an embodiment of the present invention configures the interactive module 300 with an LED touch pad, and thus it may not provide a control key when a user needs not use the control key like that where the user is listening to an MP3 file or viewing DMB continuously.

The mobile device according to an embodiment of the present invention may further include a touch input module 210 independently of the interactive input module 300. The touch input module 210 according to an embodiment of the present invention may be disposed at a certain region of the display module 200 for displaying an execution screen and sense the touch of a user, for example, may be a touch screen. The touch input module 210 senses a touch of the user to receive a second control command The mobile device further includes the touch input module 210, and thus an interface for receiving commands from the user may be variously implemented. For this, the user can more easily manipulate the mobile device.

The mobile device may include all kinds of applications for using it from multiple angles. The applications are stored in the manufacturing of the mobile device, or may be added while a user uses the mobile device after manufacture. As the applications, for example, there are a dial application, a phonebook application, a message application, a camera application, a music application, a video application, a DMB application, a recording application, an image viewer application and a text viewer application.

Control keys for controlling such various kinds of applications are inevitably different from one another according to the characteristics of the applications. Accordingly, the mobile device according to an embodiment of the present invention arranges and stores the control keys according to the applications in order to be suitable for the control of the applications by interacting with the applications, and provides a control key corresponding to an application when executing the application.

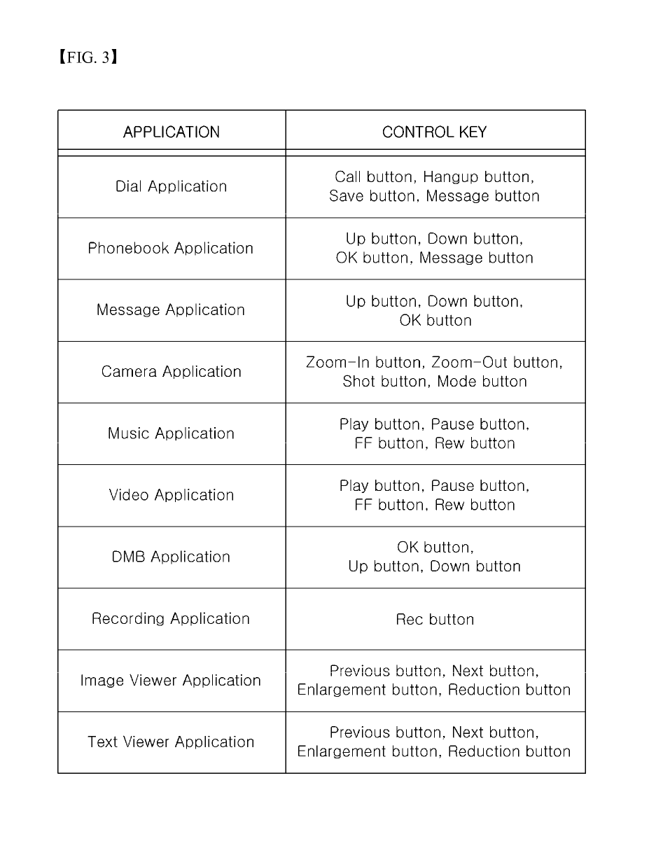

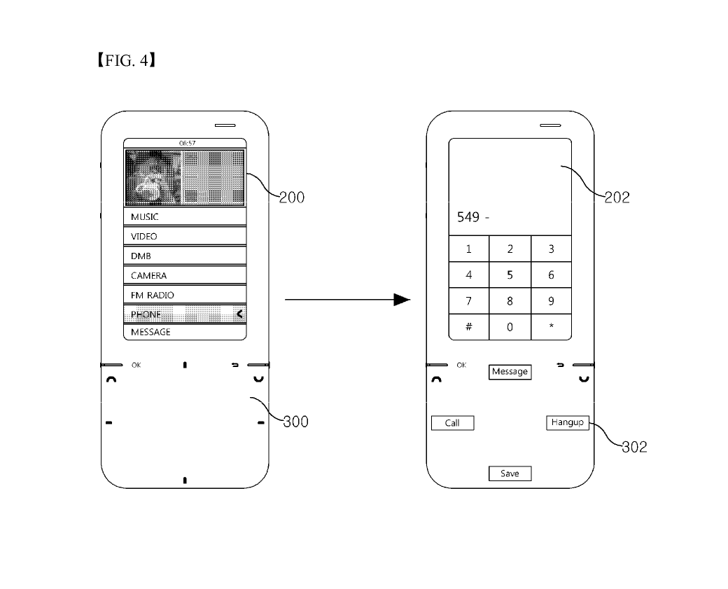

Hereinafter, a mobile device for providing control key interacting with application according to an embodiment of the present invention will be described in detail with reference to FIGS. 3 to 9. FIG. 3 is a diagram for describing various applications which may be stored in the mobile device and control keys interacting with the applications. FIGS. 4 to 9 are exemplary diagrams illustrating the execution screens of various applications.

FIG. 4 is an exemplary diagram illustrating an execution screen of a dial application according to an embodiment of the present invention.

As illustrated in FIG. 4, the dial application provides a function for making a phone call through the mobile device. When the dial application is selected by a user and is activated to an active application, the display module 200 displays the dial application 202. That is, the display module 200 displays the dial application 202 including numerals necessary for making a phone call. A control key 302 interacting with the active dial application is arranged through the interactive input module 300. The control key 302 may include at least one of a “call” button for calling to a phone number that is inputted through a dial, a “hangup” button for calling or receiving, i.e., hanging up, a “save” button for storing a phone number inputted through the dial in a phone book, and a “message” button for sending a message to a phone number that is inputted through the dial according to the characteristic of an application for making a phone call. Herein, the buttons may be appropriately arranged in order for the user to easily manipulate them.

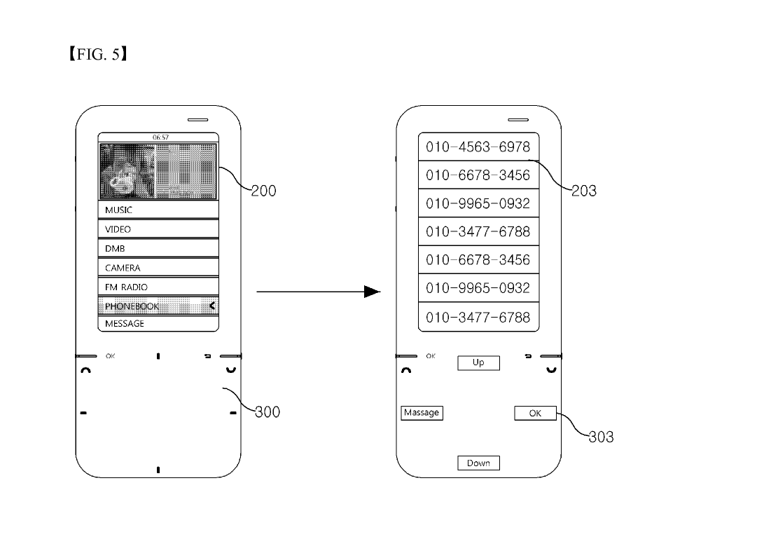

FIG. 5 is an exemplary diagram illustrating an execution screen of a phonebook application according to an embodiment of the present invention.

As illustrated in FIG. 5, the phonebook application stores names and phone numbers that respectively correspond to the names in the mobile device, and provides a function of providing a phone number when a user's request is inputted. When the phonebook application is selected by a user and is activated to an active application, the display module 200 displays the phonebook application 203. That is, the display module 200 displays a list of phone numbers that is stored in the mobile device. A control key 303 interacting with the active phonebook application is arranged through the interactive input module 300. The control key 303 may include at least one of an “UP” button for moving upward in the phone number list, a “DOWN” button for moving downward in the phone number list, an “OK” button for checking the detailed information of a focused phone number in the phone number list, and a “message” button for sending a message to a focused phone number in the phone number list according to the characteristic of the phonebook application that may provide the phone number list stored in the mobile device and connect a call or send a message to a phone number that is listed in the phone number list. Herein, the buttons may be appropriately arranged in order for the user to easily manipulate them.

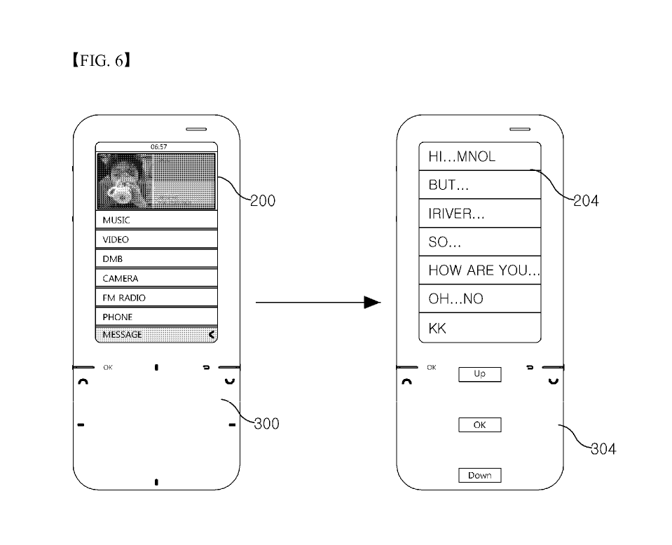

FIG. 6 is an exemplary diagram illustrating an execution screen of a message application according to an embodiment of the present invention.

As illustrated in FIG. 6, the message application stores messages such as Short Message Service (SMS) messages or Multimedia Message Service (MMS) messages that are received by the mobile device, and provides a function of displaying a message when a user's request is inputted. When the message application is selected by a user and is activated to an active application, the display module 200 displays the message application 204. That is, the mobile device provides a message list that lists received messages through the display module 200. A control key 304 interacting with the active message application 204 is arranged through the interactive input module 300. The control key 304 may include at least one of an “UP” button for moving upward in the message list, a “DOWN” button for moving downward in the message list, and an “OK” button for checking the detailed information of a focused message in the message list according to the characteristic of the message application that provides a received message and message list to the user. Herein, the buttons may be appropriately arranged in order for the user to easily manipulate them.

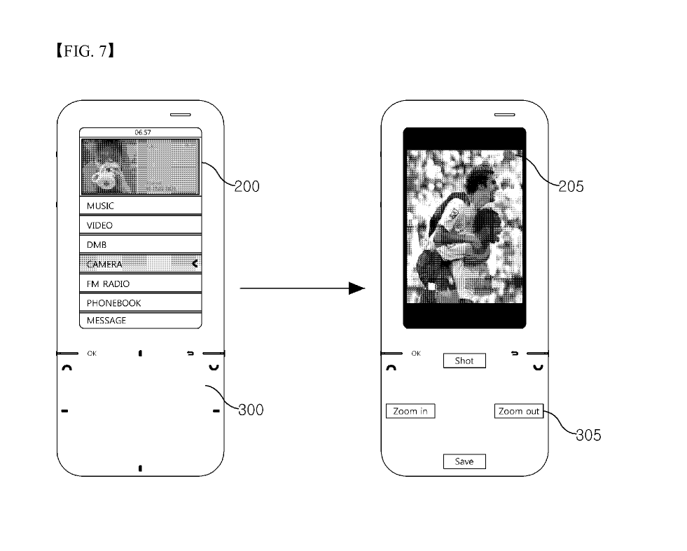

FIG. 7 is an exemplary diagram illustrating an execution screen of a camera application according to an embodiment of the present invention.

As illustrated in FIG. 7, the camera application provides a function for taking a picture to the mobile device. When the camera application is selected by a user and is activated to an active application, the display module 200 provides a captured picture. That is, the mobile device provides a captured picture through the display module 200. A control key 305 interacting with the active camera application is arranged through the interactive input module 300. The control key 305 may include at least one of a “zoom-in” button for zooming in a picture, a “zoom-out” button for zooming out the picture, a “shot” button for taking the picture, and a “mode” button for setting a photograph mode such as taking a picture at night or taking a personal picture, according to the characteristic of the camera application for taking a picture. Herein, the buttons may be appropriately arranged in order for the user to easily manipulate them.

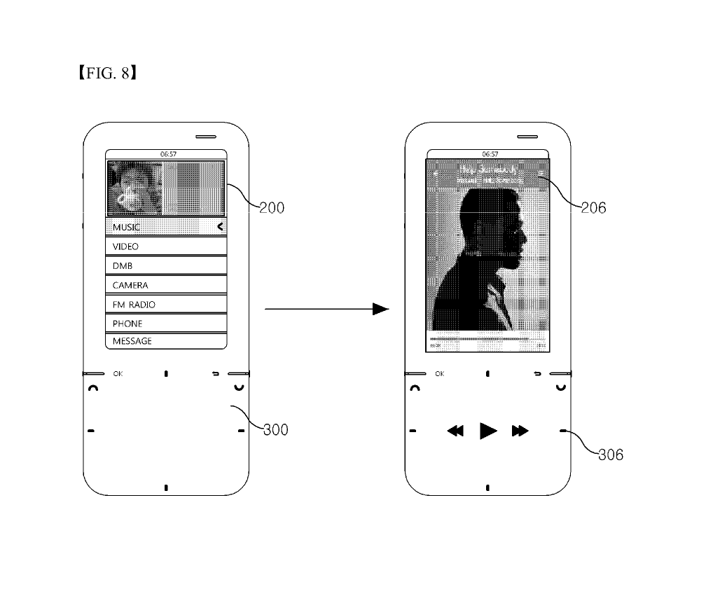

FIG. 8 is an exemplary diagram illustrating an execution screen of a music application according to an embodiment of the present invention.

As illustrated in FIG. 8, the music application provides a function for replaying music files such as MP3 files to the mobile device. When the music application is selected by a user and is activated to an active application, the display module 200 provides the information of a replayed file. That is, the mobile device provides the title, singer and lyrics of a replayed music file through the display module 200. A control key 306 interacting with the active music application is arranged through the interactive input module 300. The control key 306 may include at least one of a “play” button for playing files, a “pause” button for pausing a played file, an “FF” button for replaying a file succeeding the played file or performing fast forward in the played file, and an “REW” button for playing a file preceding the played file or performing rewind in the played file according to the characteristic of the music application that plays music files to provide music. Herein, the buttons may be appropriately arranged in order for the user to easily manipulate them.

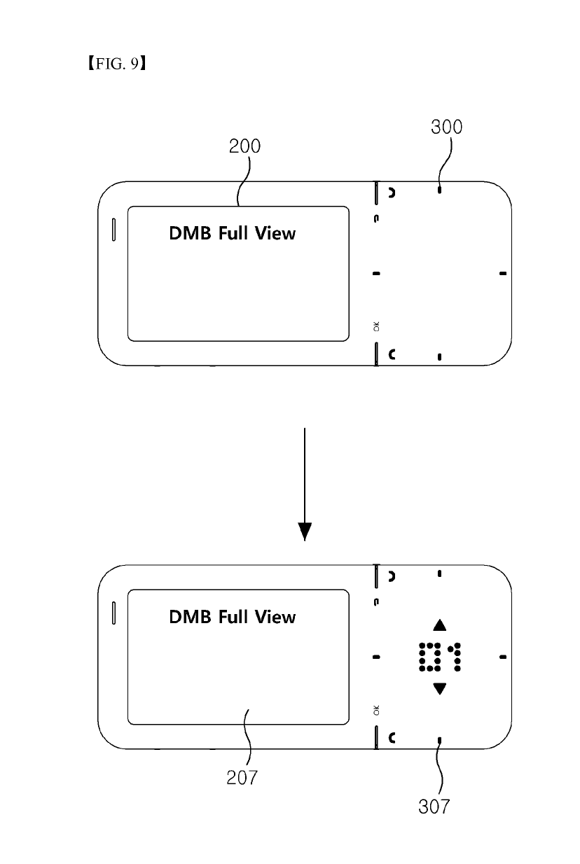

FIG. 9 is an exemplary diagram illustrating an execution screen of a DMB application according to an embodiment of the present invention.

As illustrated in FIG. 9, the DMB application provides a function for providing DMB broadcasting to the mobile device. When the DMB application is selected by a user and is activated to an active application, the display module 200 provides broadcasting received. That is, the mobile device provides the broadcasting and information of a received channel through the display module 200. A control key 307 interacting with the active DMB application is arranged through the interactive input module 300. The control key 307 may include at least one of an “OK” button for checking the information of a channel that is being viewed, an “UP” button for moving to a channel preceding the channel that is being viewed, and a “DOWN” button for moving to a channel succeeding the channel that is being viewed according to the characteristic of the DMB application that provides DMB broadcasting. Herein, the buttons may be appropriately arranged in order for the user to easily manipulate them.

According to an embodiment of the present invention, furthermore, an active application may be a recording application. When the recording application is selected by a user and is activated to an active application, the display module 200 provides a current-recording state. That is, the mobile device provides record information through the display module 200. A control key interacting with the active recording application is arranged through the interactive input module 300. The control key interacting with the active recording application may include an REC button for recording sound according to the characteristic of the recording application. Herein, the button may be appropriately arranged in order for the user to easily manipulate them.

According to an embodiment of the present invention, moreover, an active application may be an image viewer application or a text viewer application. When the image viewer application or the text viewer application is selected by a user and is activated to an active application, the display module 200 provides an image file or a text file. A control key interacting with the image viewer application or the text viewer application is arranged through the interactive input module 300. The control key interacting with the active recording application may include a previous button, a next button, an enlarge button for enlarging a viewer screen, and a reduce button for reducing the viewer screen. Herein, the button may be appropriately arranged in order for the user to easily manipulate them.

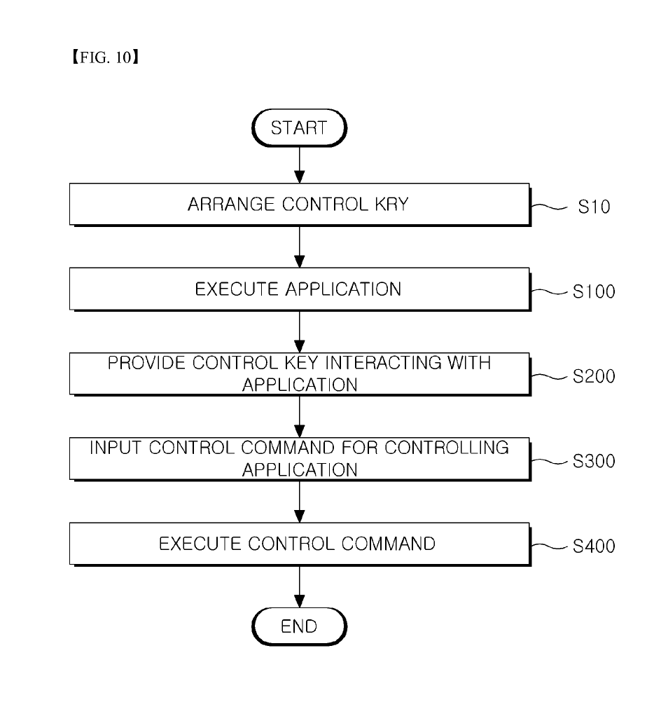

FIG. 10 illustrates a method for providing control key interacting with application according to an embodiment of the present invention.

Referring to FIG. 10, the mobile device may include all kinds of applications for using it from multiple angles. The applications are stored in the manufacturing of the mobile device, or may be added while a user uses the mobile device after manufacture. As the applications, there are a dial application for making a phone call through the mobile device, a phonebook application for storing names and phone numbers that respectively correspond to the names, a message application for writing an SMS message or an MMS message and sending it, a camera application for taking a picture, a music application for replaying music files to provide music, a video application for replaying video files to provide video, a DMB application for providing a digital broadcasting service, a recording application for recording sound, an image viewer application for viewing image files and a text viewer application for viewing text files.

Control keys for controlling such various kinds of applications are inevitably different from one another according to the characteristics of the applications. Accordingly, the mobile device may perform a control key arranging operation S10 that arranges and stores the control keys according to the applications in order to be suitable for the control of the applications by interacting with an application executed. The control key may be configured with one button or a plurality of buttons according to the kinds of applications, and also the positions of the buttons may be differently arranged according to the kinds of applications in order for a user to easily manipulate them.

After storing the applications and the control key in operation S10, the mobile device may perform an application executing operation S100 of executing an application. In the application executing operation S100, the mobile device including at least one application receives the selection of the user and executes the application included in the mobile device. Herein, the executed application is referred to as an active application.

After the application executing operation S100, the mobile device performs a control key providing operation S200 that provides a control key interacting with the active application. The control key may be provided through an LED touch pad.

After the control key providing operation S200, the mobile device may further perform a control command receiving operation S300 that receives a control command for controlling the active application through the control key.

After the control command receiving operation S300, the mobile device may further perform a control command executing operation S400 that controls the active application according to the control command.

The mobile device and method for providing control key interacting with application according to embodiments of the present invention provide the control keys that interact with applications and may be adaptively changed according to the kinds of applications by interacting with the applications, and thus enable a user to control the mobile device more intuitively and easily.

The mobile device and method for providing control key interacting with application according to embodiments of the present invention can control applications by arranging the applications that were not considered in the manufacturing of the mobile device and control keys for controlling the application later because the control keys are not physically provided to the mobile device.

The mobile device and method for providing control key interacting with application according to embodiments of the present invention implement the control key as the LED touch pad and do not provide a control key when the mobile device is not controlled, thereby increasing the use time of a battery and enabling a user to visually obtaining stability.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile device including at least one or more applications executable by the mobile device, the mobile device comprising:
an application executing module activating an application, which is selected from among the applications by a user, to execute an active application;
a display module displaying an execution screen of the active application; and
an interactive input module receiving a control command for controlling the active application from the user,
wherein the interactive input module provides a control key which is arranged to be suitable for control of the active application by interacting with the active application, and receives the control command for controlling the active application through the control key.

2. The mobile device of claim 1, wherein:
the mobile device further comprises a database storing the applications, and the control key which is arranged in the interactive input module to be suitable for control of the applications in response to the applications, and
the application executing module is executed to provide the control key interacting with the active application through the interactive input module.

3. The mobile device of claim 1, wherein the interactive input module comprises a Light Emitting Diode (LED) touch pad.

4. The mobile device of claim 1, further comprising a touch input module disposed at a certain region of the display module which displays the execution screen, and sensing touch of the user,
wherein the touch input module senses the touch of the user to receive a second control command.

5. The mobile device of claim 2, wherein the database stores at least one of: a dial application for making a phone call through the mobile device; a phonebook application for storing names and phone numbers which respectively correspond to the names; a message application for writing a Short Message Service (SMS) message or a Multimedia Message Service (MMS) message and sending the message; a camera application for taking a picture; a music application for replaying music files to provide music; a video application for replaying video files to provide video; a Digital Multimedia Broadcasting (DMB) application for providing a digital broadcasting service; a recording application for recording sound; an image viewer application for viewing image files; and a text viewer application for viewing text files.

6. The mobile device of claim 5, wherein when the active application is the dial application,
a dial is provided through the display module, and
the control key comprises at least one of: a call button for calling to a phone number which is inputted through the dial; a hangup button for hanging up; a save button for storing a phone number inputted through the dial in a phone book; and a message button for sending a message to a phone number which is inputted through the dial.

7. The mobile device of claim 5, wherein when the active application is the phonebook application,
a stored phone number list is provided through the display module, and
the control key comprises at least one of: an UP button for moving upward in the phone number list; a DOWN button for moving downward in the phone number list; an OK button for checking detailed information of a focused phone number in the phone number list; and a message button for sending a message to a focused phone number in the phone number list.

8. The mobile device of claim 5, wherein when the active application is the message application,
a stored message list is provided through the display module, and
the control key comprises at least one of: an UP button for moving upward in the message list; a DOWN button for moving downward in the message list; and an OK button for checking detailed information of a focused message in the message list.

9. The mobile device of claim 5, wherein when the active application is the camera application,
a captured picture is provided through the display module, and
the control key comprises at least one of: a zoom-in button for zooming in the picture; a zoom-out button for zooming out the picture; a shot button for taking the picture; and a mode button for setting a photograph mode.

10. The mobile device of claim 5, wherein when the active application is the music application or the video application,
an executed file is provided through the display module, and
the control key comprises at least one of: a play button for playing files; a pause button for pausing a played file; an FF button for replaying a file succeeding the played file or performing fast forward in the played file; and an REW button for playing a file preceding the played file or performing rewind in the played file.

11. The mobile device of claim 5, wherein when the active application is the DMB application,
DMB broadcasting is provided through the display module, and
the control key comprises at least one of: an OK button for checking information of a channel which is being viewed; an UP button for moving to a channel preceding the channel which is being viewed; and a DOWN button for moving to a channel succeeding the channel which is being viewed.

12. The mobile device of claim 5, wherein when the active application is the recording application,
a current-recording state is provided through the display module, and
the control key comprises an REC button for recording sound.

13. The mobile device of claim 5, wherein when the active application is the image viewer application or the text viewer application,
a file is provided through the display module, and
the control key comprises at least one of: a previous button; a next button; an enlarge button for enlarging a viewer screen; and a reduce button for reducing the viewer screen.

14. A method for providing control key of a mobile device including at least one or more applications, the method comprising:
activating an application, which is selected from among the applications comprised in the mobile device by a user, to execute an active application; and
providing a control key which is arranged to be suitable for control of the application by interacting with the active application.

15. The method of claim 14, wherein before the executing of an active application,
the method further comprises arranging and storing, by the mobile device, the applications and the control key to be suitable for control of the applications in response to the applications.

16. The method of claim 15, wherein after the providing of a control key,
the method further comprises receiving a control command for controlling the active application through the control key.

17. The method of claim 16, wherein after the receiving of a control command,
the method further comprises controlling the active application according to the control command.

18. The method of claim 14, wherein in the providing of a control key, the control key is provided through a Light Emitting Diode (LED) touch pad.

19. The method of claim 15, wherein the arranging and storing of the applications and the control key store at least one of: a dial application for making a phone call through the mobile device; a phonebook application for storing names and phone numbers which respectively correspond to the names; a message application for writing a Short Message Service (SMS) message or a Multimedia Message Service (MMS) message and sending the message; a camera application for taking a picture; a music application for replaying music files to provide music; a video application for replaying video files to provide video; a Digital Multimedia Broadcasting (DMB) application for providing a digital broadcasting service; a recording application for recording sound; an image viewer application for viewing image files; and a text viewer application for viewing text files.
